(19) United States
(12) Patent Application Publication
(10) Pub. No.: US 2016/0032117 A1
(43) Pub. Date: Feb. 4, 2016

(54) PIGMENTED POLYURETHANE DISPERSION

(71) Applicant: XEROX CORPORATION, NORWALK, CT (US)

(72) Inventors: JEFFERY H. BANNING, Cedar Rapids, IA (US); Kelley A. Moore, Salem, OR (US); Jian Yao, Portland, OR (US); Jule W. Thomas, JR., West Linn, OR (US); Michael B. Meinhardt, Lake Oswego, OR (US); Wolfgang Wedler, Tualatin, OR (US)

(21) Appl. No.: 14/451,408

(22) Filed: Aug. 4, 2014

(51) Int. Cl. C09D 11/30; C09D 175/06; C09D 175/08

(52) U.S. Cl. CPC C09D 11/30; C09D 175/08; C09D 175/06

(57) ABSTRACT

The present disclosure provides a pigment dispersion and an inkjet ink comprising an ink vehicle and a pigment dispersion thereof. The present disclosure also provides a process for producing the aqueous pigment.

### CROSS-REFERENCE TO RELATED APPLICATIONS

Reference is made to commonly owned and co-pending, U.S. patent application Ser. No. ______ (not yet assigned) entitled “Encapulated Visible Light Absorbing Dye Polyurethane Dispersion” to Jeffrey Banning et al., electronically filed on the same day herewith (Attorney Docket No. 20131653-429480); U.S. patent application Ser. No. ______ (not yet assigned) entitled “Encapulated Titanium Dioxide, Fluorescent Pigments, and Pigmented Polyurethane Dispersion” to Jeffrey Banning et al., electronically filed on the same day herewith (Attorney Docket No. 20131658-430291); U.S. patent application Ser. No. ______ (not yet assigned) entitled “Encapulated Fluorescent and Photochromic Dye Polyurethane Dispersion” to Jeffrey Banning et al., electronically filed on the same day herewith (Attorney Docket No. 20131661-430294); the entire disclosures of which are incorporated herein by reference in its entirety.

### INTRODUCTION

Typical latex particles are prepared via emulsion polymerization. Emulsion polymerizations are categorized as a chain growth polymerization where unsaturated monomers (anionic, cationic, or free radical) add onto the active site of a growing polymer chain one at a time. Latexes of an emulsion polymerization process are usually stabilized by surfactant generated micelles. However, the stability of these latexes can easily be disturbed if a solid/liquid, such as a colorant, is added to the latex system. For example, the addition of charged species (e.g., commercial pigments stabilized by charged polymers and/or surfactants) to latexes formed from an emulsion polymerization process may destabilize the latex system and cause it to coagulate.

Polyurethane reactions are categorized as a step growth polymerization which employs co-monomers such as isocyanate monomers (e.g., diisocyanates, triisocyantes), polyol monomers (e.g., dialcohols, triols), amine monomers (e.g., diamines, triamines). Latexes of polyurethane dispersions of the present disclosure are stabilized by a “built in” surfactant, e.g., dimethylol propionic acid (DMPA), with a neutralizing agent. As a result, the properties of latex particles of polyurethane dispersions and the subsequent films formed from the polyurethane disperions (i.e., when the water evaporates and the particles coalesce and begin to interdiffuse and eventually become a homogeneous film) are quite different from that of emulsion polymerization. During the dispersion process in making the pigmented polyurethane dispersions of the present disclosure, a aqueous stabilized pigment can be added to the water used to disperse the neutralized prepolymer, thus the addition of pigments does not adversely affect the PU-Dispersion stability.

Polyurethane dispersions (PUDs) have been employed as carriers in aqueous ink jet inks, for example, U.S. Pat. No. 5,700,851, and aqueous writing inks, for example, U.S. Pat. No. 5,637,638, which are both hereby incorporated by reference. The dispersions described in these patents employed reactive polymeric colorants that are built into the polyurethane backbone of the molecule by covalent bonding, and act as the source of coloration of the final ink.

Apart from the previous polyurethane dispersions disclosures, the pigmented polyurethane dispersions of the present disclosure include a stabilized pigment that is not covalently bonded to the polyurethane backbone.

It is important that ink compositions comprising pigment dispersion remain stable, not only in storage but also over repeated jetting cycles. Therefore, a need exists for a method to incorporate pigments into the latex, to provide a highly stable pigment polyurethane dispersion, which may be used for ink-jet applications.

### BRIEF DESCRIPTION OF THE FIGURES

FIG. 1 shows a water-in-oil aqueous dispersion of a mixture of an aqueous stabilized pigment and a neutralized prepolymer according to certain embodiments of the present disclosure.

FIG. 2 shows an oil-in-aqueous dispersion of a mixture of an aqueous stabilized pigment and a neutralized prepolymer after high speed spinning according to certain embodiments of the present disclosure.

FIG. 3 shows a close up view of a single pigmented dispersion particle in water according to certain embodiments of the present disclosure.

FIG. 4 shows a close up view of a single dispersion particle after the addition of a chain extender dispersion according to certain embodiments of the present disclosure.

### SUMMARY OF THE EMBODIMENTS

The disclosure provides a pigment dispersion comprising: a polyurethane dispersion that is the reaction product of: (a) a urethane prepolymer, the urethane prepolymer being a catalyzed reaction product of: (i) a polyol; (ii) a polyisocyanate; and (iii) an internal surfactant; (b) a neutralizing agent; and (c) a chain extender; and an aqueous pigment dispersion comprising a pigment that is not reactive towards the polyisocyanate.

In further embodiments, the disclosures provides an pigment dispersion comprising: a polyurethane dispersion that is the reaction product of: (a) a urethane prepolymer, the urethane prepolymer being a catalyzed reaction product of: (i) a polyol; (ii) a polyisocyanate; and (iii) an internal surfactant; wherein the stoichiometric equivalent molar ratio of internal surfactant to polyol is from about 0.5 to about 2.0 and the stoichiometric equivalent molar ratio of NCO groups to total OH groups in the prepolymer is from about 1.2 to about 2.0; (b) a neutralizing agent; and (c) a chain extender; and an aqueous pigment dispersion comprising a pigment that is not reactive towards the polyisocyanate; further wherein the pigment dispersion has an average particle size of from about 20 nm to about 900 nm, a viscosity of from about 2 to about 150 cps at room temperature, and a surface tension of from about 15 to about 65 dyn at room temperature.

In embodiments, the disclosures also provides an ink jet ink composition comprising a pigment dispersion comprising: a polyurethane dispersion that is the reaction product of: (a) a urethane prepolymer, the urethane prepolymer being a catalyzed reaction product of: (i) a polyol; (ii) a polyisocyanate; and (iii) an internal surfactant; (b) a neutralizing agent; and (c) a chain extender; and a pigment dispersion comprising a pigment that is not reactive towards the polyurethance dispersion.

### DETAILED DESCRIPTION

As used herein, the term “dispersion” means a two phase system where one phase consists of finely divided particles (often in the colloidal size range) distributed throughout a bulk substance, the particles being the dispersed or internal phase and the bulk substance the continuous or external phase. The bulk system is often an aqueous system.

As used herein, the term “PUD” means the polyurethanes dispersions described herein.

As used herein, the term “DMPA” means dimethylol propionic acid.

Disclosure provides a pigment dispersion including a polyurethane dispersion and an aqueous pigment dispersion including a pigment that is unreactive towards any reagent/or precursor of the urethane prepolymer (i.e., the polyol, the polyisocyanate, and/or the internal surfactant). The polyurethane dispersion of the disclosure is a reaction product of (a) a urethane prepolymer, (b) a neutralizing agent, and (c) a chain extender, where the urethane prepolymer is prepared from (i) a polyol, (ii) a polyisocyanate, and (iii) an internal surfactant.

When preparing the pigment dispersion of the present disclosure, a stabilized pigment may be incorporated into the polyurethane dispersion by including an aqueous pigment dispersion that contains the stabilized pigment, during the formation of the polyurethane dispersion. The aqueous pigment dispersion can be prepared by adding a pigment(s) to water, which is referred to as the dispersion process. Preparing and including an aqueous pigment dispersion after the formation of the pre-polymer results in a stable pigment dispersion. All other attempts to include “commercial pre-stabilized” pigments into the pre-polymer (either at the beginning, or during the formation of the pre-polymer) fail to produce a stable pigment dispersion. Simply adding or mixing a pre-stabilized pigment with a polyurethane dispersion does not produce the stable pigment dispersion of the present disclosure. This is because the stabilized pigment interferes with the formation of the prepolymer and subsequent neutralization and dispersion.

The pigment dispersion may be prepared by a process including providing a urethane prepolymer; neutralizing the urethane prepolymer with a neutralizing agent; adding an aqueous stabilized pigment dispersion as part of the water added to the neutralized prepolymer to form an aqueous pigment dispersion of the neutralized prepolymer; and reacting the aqueous pigment dispersion of the neutralized prepolymer with a chain extender thereby producing an pigment containing PU-dispersion.

The urethane prepolymer can be prepared by reacting a polyol, a polyisocyanate, and an isocyanate reactive internal surfactant in the presence of a catalyst.

The internal surfactant may be dissolved in an organic solvent, such as NMP, DMF, or other polar aprotic solvents, prior to the addition to the polyol and polyisocyanate.

Generally, the stoichiometric equivalent molar ratio of isocyanate reactive internal surfactant to polyol may be from about 0.5 to about 2, from about 0.75 to about 1.75, or from about 1 to about 1.5, the stoichiometric equivalent molar ratio of NCO groups to total OH groups in the prepolymer may be from about 1.0 to about 3.0, from about 1.25 to 2.5 to about 1.5 to 2.0. It is desired to have a high internal surfactant to polyol ratio and a low NCO group to OH group ratio. Typically, the urethane prepolymer reaction is carried out at about 65° C. to about 100° C. for about 1 to about 5 hours until the theoretical isocyanate content, which can be determined by titration, e.g., the di-n-butylamine titration method, is reached to form an urethane prepolymer (isocyanate-terminated) containing an internal surfactant therein.

The urethane prepolymer (isocyanate terminated prepolymer containing a covalently bound internal surfactant therein) can be neutralized with a neutralizing agent, such as a trialkylamine, e.g., triethylamine. The amount of neutralizing agent used may be dependent upon the amount of internal surfactant present in the urethane prepolymer, and ranges from about 5% to about 105%, from about 10% to about 90% or from about 20% to about 70% of the quantity of internal surfactant. This neutralization step allows the urethane prepolymer to be dispersible by neutralizing the functional groups of the urethane prepolymer. In one embodiment, the carboxylic acid sites on the internal surfactants may be neutralized thereby forming a salt, such as —CO₂⁻HN⁺R₃, where R is a lower alkyl group.

The neutralized prepolymer, typically, has an average weight molecular weight (MW) of from about 1,000 to about 20,000, from about 3,000 to about 15,000, or from about 5,000 to about 10,000.

An aqueous dispersion containing water (e.g., deionized (DI) water) and a pigment may be added, at room temperature, to the neutralized prepolymer under conventional dispersion-forming conditions such as being subjected to a IKA® Crushing Disperser rotating at approximately 7,500 rpms for about 15 seconds. The particle size of the dispersion is set at this point. Mild agitation is then undertaken and a chain extender added and allowed to react/set for a couple of days before using the PUD. The conventional dispersion-forming conditions are also described in, for example, U.S. Pat. No. 5,700,851.

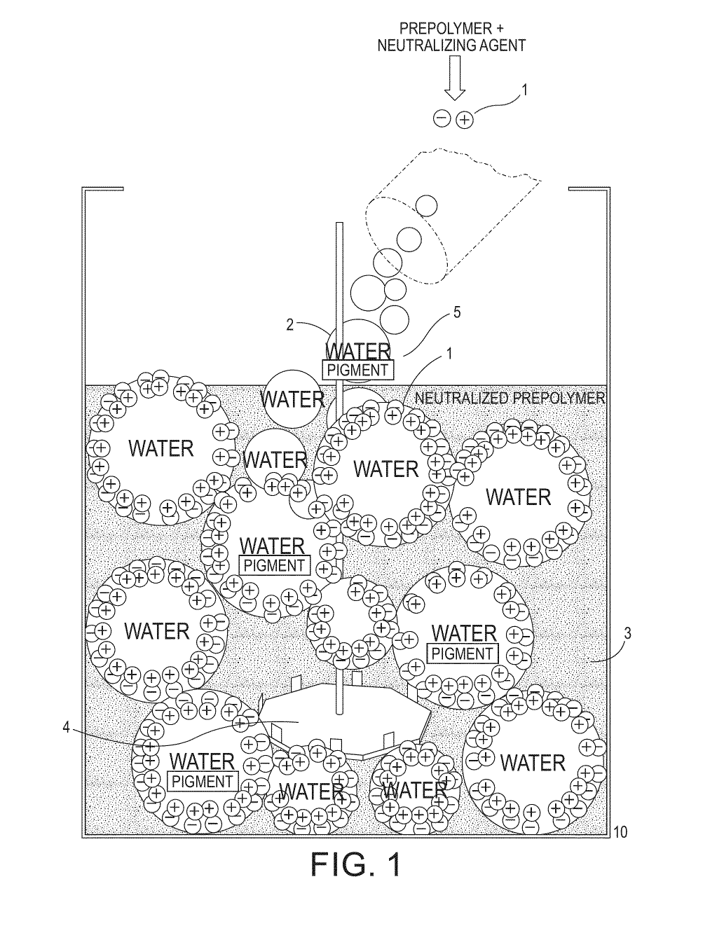

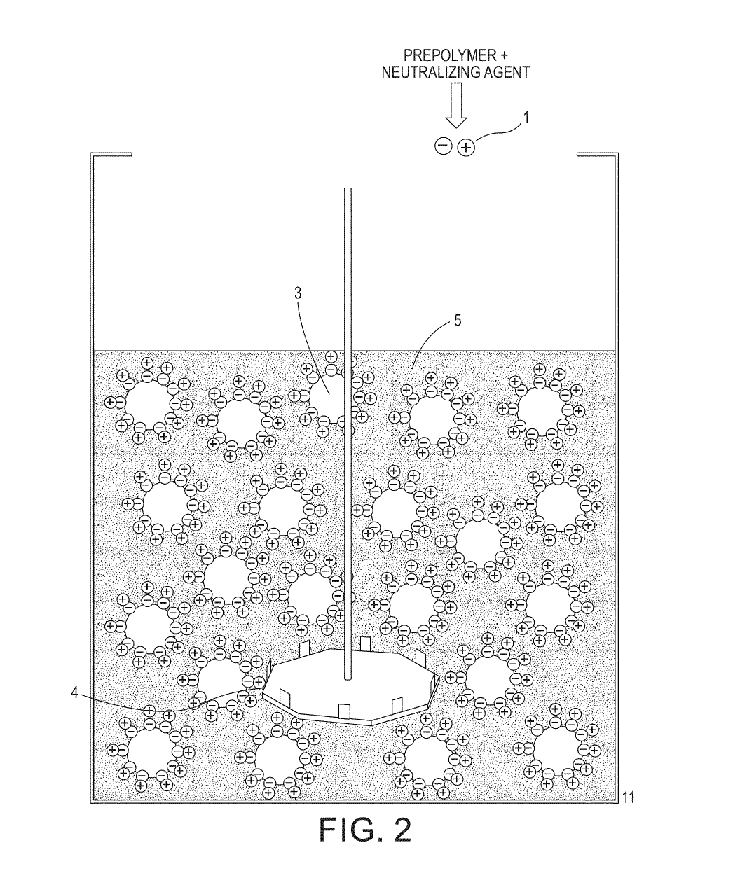

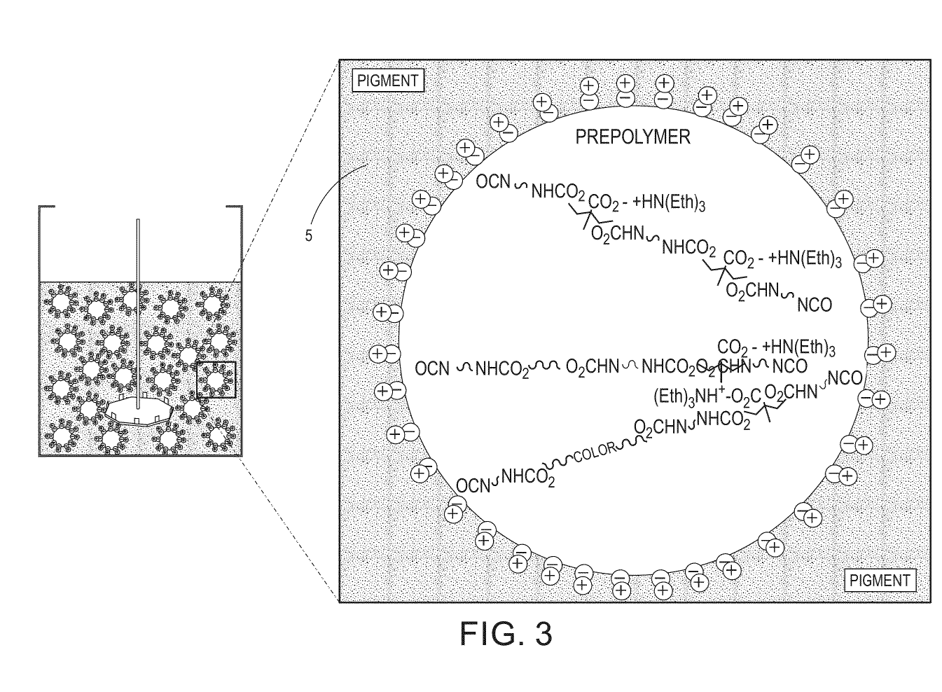

The amount of water in the aqueous dispersion is based on the desired percentage of solids in the final polyurethane dispersion, which may be in amount of from about 1.0 to about 99 percent, from about 20 to about 80 or from about 35 to about 60 percent based on the total weight of the aqueous dispersion. The aqueous dispersion usually starts out as a “water-in-oil” dispersion prior to the addition to the neutralized prepolymer. FIG. 1 shows a “water-in-oil” aqueous dispersion when a mixture of a pigment 2 and DI water (aqueous dispersion 5) is first dispersed into a neutralized prepolymer 3, where the neutralized prepolymer 3 can be prepared by contacting a prepolymer and a neutralizing agent. The pigment 2 is stabilized in a droplet of water in the aqueous dispersion 5. During the dispersion process, the mixture (i.e., the aqueous dispersion 5 and the neutralized prepolymer 3) may be spinned at high speed (e.g., 5,000-10,000 rpms) and the “water-in-oil” aqueous dispersion may be converted to an “oil-in-water” dispersion. The dispersion can be accomplished by spinning a blade, such as a dispersion blade 4. The effect of employing a dispersion blade at high speed imparts energy into the system to disperse rather than to mix. At this point, the particle size of the pigment dispersion may be determined. FIG. 2 shows an “oil-in-water” aqueous dispersion, where the neutralized prepolymer 3 is suspended in the aqueous dispersion 5. Inside a droplet of the neutralized prepolymer 3, the terminals (i.e., free —NCO groups) of the neutralized prepolymer are at the inside surface of the droplet. In one embodiment of the disclosure, FIG. 3 shows a close up view of a single dispersion particle in water, where DMPA is employed as the internal surfactant.

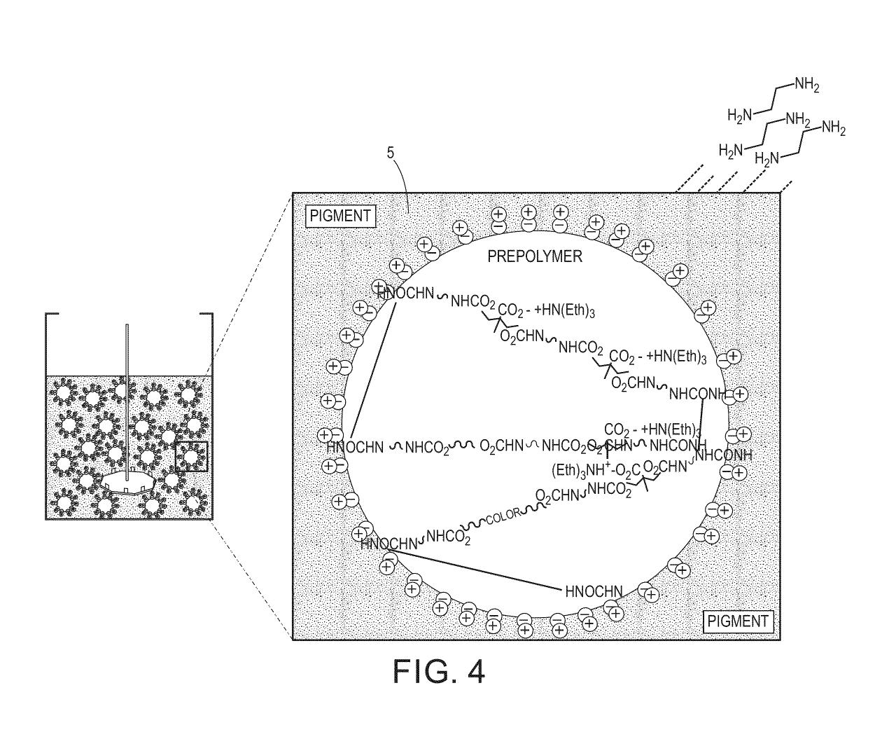

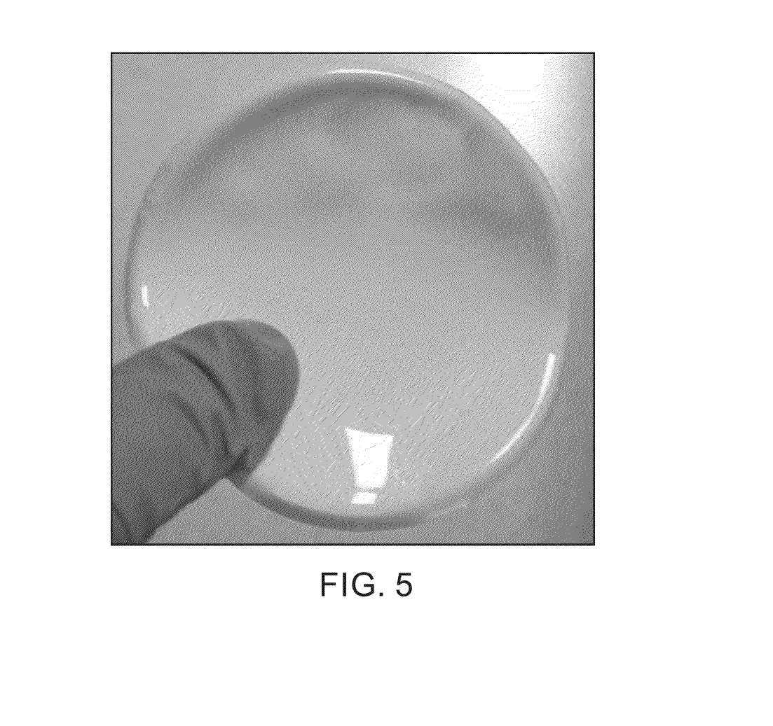

A chain extender such as a suitable diamine, triamine, diol or a triol, may then be added to increase the average weight molecular weight of the polyurethane dispersion by using an amount stoichiometrically equivalent to from about 60 to about 100 percent of the amount of prepolymer, or from about 85 to about 95 percent of the amount of the prepolymer. The average weight molecular weight of the polyol employed and the particular chain extender used can impact the adhesion of the ink to the final receiving substrate. The chain extender may diffuse or migrate into the particles of the dispersion and react with the terminated free isocyanate groups of the neutralized prepolymer, and thus extend the molecular weight of the polyurethane polymer and form ureas in the process. In one embodiment of the disclosure, FIG. 4 shows a close up view of a single dispersion particle after the addition of a chan extender, e.g., ethylene diamine in water, where DMPA is employed as the internal surfactant.

Examples of the chain extender suitable for use in the present disclosure include diamines such as ethylenediamine, 1,2-propanediamine, 1,6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, and 1,4-cyclohexanediamine; diamines containing one primary amino group and one secondary amino group such as N-hydroxymethylaminoethylamine, N-hydroxyethylaminoethylamine, N-hydroxypropylaminopropylamine, N-ethylaminoethylamine, and N-methylaminopropylamine; polyamines such as diethylenetriamine, dipropylenetriamine, and triethylenetetramine. In one embodiment, the chain extender includes ethylene diamine.

Any suitable amounts of prepolymer, neutralizing agent, water and chain extender may be added to the urethane prepolymer as long as a stable pigmented polyurethane dispersion is formed.

As a stirring/dispersing device for dispersing pigments, for example, various known dispensers such as a high speed impeller disc, an ultrasonic homogenizer, a high-pressure homogenizer, a paint shaker, a ball mill, a roll mill, a sand mill, a sand grinder, a dyno mill, dispermat, an SC mill, a nanomizer, or the like can be used.

The pigment polyurethane dispersion is then combined with an aqueous medium, at least one humectant, and optionally at least one plasticizer.

The pigment dispersion of the present disclosure may have an average dispersion particle size (i.e., particle diameter) of from about 20 nm to about 900 nm, from about 30 nm to about 600 nm, or from about 50 nm to about 100 nm. This size range permits the particles and the resultant ink in which they are dispersed to overcome settling and stability/dispersing problems. The average particle diameter can be measured by various methods, for example, they can be measured using a particle analyzer UPA 150 manufactured by Nikkiso Co., Ltd.

The pigment dispersion of the present disclosure may have a viscosity of from about 2 to about 150 cps, from about 10 to about 100 cps, or from about 20 to about 80 cps at room temperature. The pigment dispersion of the present disclosure may have a surface tension of from about 15 to about 65 dyn, from about 25 to about 60 dyn, or from about 35 to about 55 dynes, at room temperature.

The pigment content of the pigment dispersion of the present disclosure may be in the range of from about 0.1 to about 30 percent, from about 1.0 to about 15 percent, or from about 2.0 to about 5.0 percent by weight of the pigment dispersion. The pigment generally has an average pigment particle size (i.e., particle diameter) of from about 20 nm to about 900 nm, from about 50 nm to about 500 nm, or from about 100 nm to about 250 nm.

The aqueous pigment dispersion contains one or more pigments. The pigment may be present from about 1% to about 70%, from about 2.0 to about 50 percent, or from about 3.0 to about 25.0 by weight based on the total weight of the aqueous pigment dispersion.

The pigments of the present disclosure are unreactive towards any reagent/or precursor of the urethane prepolymer (i.e., the polyol, the polyisocyanate, and the internal surfactant). Particularly, the pigments do not contain any hydroxyl group or amine group.

The pigments used in the present disclosure can utilize any of the variety of pigments used in ink jet inks, which include black, yellow, magenta, cyan, and other color pigments, or mixtures thereof. Commercial pre-dispersed pigments may be used in the present disclosure.

Specific examples of black pigments include carbon blacks such as furnace black, lamp black, acetylene black and channel black; powders including one or more metals such as copper powder, iron powder and titanium oxide powders; and organic pigments such as o-nitroaniline black and the like. Specific examples of the yellow pigments include Pigment Yellows 1, 2, 3, 12, 13, 14, 16, 17, 73, 74, 75, 83, 93, 95, 97, 98, 114, 120, 128, 129, 138, 150, 151, 154, 155, 180, etc.

Specific examples of the yellow pigments include Pigment Yellows 1, 2, 3, 12, 13, 14, 16, 17, 73, 74, 75, 83, 93, 95, 97, 98, 114, 120, 128, 129, 138, 150, 151, 154, 155, 180, etc.

Specific examples of the magenta pigments include Pigment Reds 5, 7, 12, 48 (Ca), 48 (Mn), 57 (Ca), 57:1, 112, 122, 123, 168, 184, 202, etc.; Pigment Violet 19; etc.

Specific examples of the cyan pigments include Pigment Blues 1, 2, 3, 15, 15:3, 15:4, 16, 22 and 60; Vat Blue 4 and 60; etc.

Specific examples of other color pigments include toluidine red, Permanent Carmine FB, Fast Yellow AAA, Disazo Orange PMP, Lake Red C, Brilliant Carmine 6B, Phthalocyanine Blue, Quinacridone Red, Dioxane Violet, Victoria Pure Blue, Alkali Blue Toner, Fast Yellow 10G, Disazo Yellow AAMX, Disazo Yellow AAOT, Disazo Yellow AAOA, yellow iron oxide, Disazo Yellow HR, o-nitroaniline orange, dinitroaniline orange, Vulcan Orange, chlorinated Para Red, Brilliant Fast Scarlet, Naphthol Red 23, Pyrazolone red, Barium Red 2B, Calcium Red 2B, Strontium Red 2B, Manganese Red 2B, Barium Rithol Red, Pigment Scarlet 3B Lake, Lake Bordeaux 10B, Anthocyne 3B Lake, Anthocyne 5B Lake, Rhodamine 6G Lake, Eosin Lake, red iron oxide, Fanatol Red FGR, Rhodamine B Lake, Methyl Violet Lake, dioxazine violet, Basic Blue 5B Lake, Basic Blue 6G Lake, Fast Sky Blue, Alkali Blue R Toner, Peacock Blue Lake, Prussian Blue, ultramarine blue, Reflex Blue 2G, Reflex Blue R, Brilliant Green Lake, Diamond Green, Thioflavine Lake, Phthalocyanine Green G, Green Gold, Phthalocyanine Green Y, iron oxide powders, red rust, zinc oxide, titanium oxide, calcium carbonate, clay, barium sulfate, alumina, alumina white, aluminum powders, bronze powders, fluorescent pigments, pearl pigments, Naphthol Carmine FB, Naphthol Red M, Fast Yellow G, Disazo Yellow AAA, dioxane violet, Alkali Blue G Toner and the like.

These pigments can be used alone or in combination.

In one embodiment, the pigment of the present disclosure includes a quinacridone pigment (e.g., PR 122 know as Pro-Jet Magenta APD1000 from the FujiFilm Corp.) which is having the following structure:

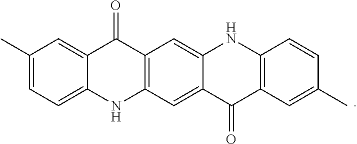

In certain embodiments, the pigment of the present disclosure includes aTiO₂ pigment, Eastman (from Easttack pigment), or Cabot Carbon black.

As used herein, the term “polyol” is intended to include materials that contain two or more hydroxyl groups, e.g., diol, triol, tetraol, etc. The average weight molecular weight of the polyol may be in the range of from about 60 to about 10,000, from about 500 to about 5000, or from about 1000 to about 2000. Non-limiting examples of polyols include diols, triols, polyether polyols, polyacrylate polyols, polyester polyols, polycarbonate polyols, and combinations thereof. Suitable polyether polyol include, but are not limited to, polytetramethylene ether glycol (PTMEG), polyethylene propylene glycol, polyoxypropylene glycol, and mixtures thereof. The hydrocarbon chain can have saturated or unsaturated bonds and substituted or unsubstituted aromatic and cyclic groups. Suitable polyacrylate polyols include, but are not limited to, glycerol 1,3-diglycerolate diacrylate. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. Suitable polycarbonate polyols include, but are not limited to, poly(polyTHFcarbonate)diol.

As used herein, the term “polyisocyanate” is intended to include materials that contain two or more isocyanate groups. The average weight molecular weight of the polyisocyanate may be in the range of from about 140 to about 1000, from about 168 to about 262, or from about 222 to about 680. Suitable polyisocyanates include diisocyanates, triisocyanates, copolymers of a diisocyanate, copolymers of a triisocyanate, polyisocyanates (having more than three isocyanate functional groups), and the like, as well as mixtures thereof. Examples of diisocyanates include isophorone diisocyanate (IPDI); toluene diisocyanate (TDI); diphenylmethane-4,4′-diisocyanate (MDI); hydrogenated diphenylmethane-4,4′-diisocyanate (H12MDI); tetra-methyl xylene diisocyanate (TMXDI); hexamethylene-1,6-diisocyanate (HDI); hexamethylene-1,6-diisocyanate; napthylene-1,5-diisocyanate; 3,3′-dimethoxy-4,4′-biphenyldiisocyanate; 3,3′-dimethyl-4,4′-bimethyl-4,4′-biphenyldiisocyanate; phenylene diisocyanate; 4,4′-biphenyldiisocyanate; trimethylhexamethylene diisocyanate; tetramethylene xylene diisocyanate; 4,4′-methylenebis(2,6-diethylphenyl isocyanate); 1,12-diisocyanatododecane; 1,5-diisocyanato-2-methylpentane; 1,4-diisocyanatobutane; dimer diisocyanate and cyclohexylene diisocyanate and its isomers; uretidione dimers of HDI; and the like, as well as mixtures thereof. Examples of triisocyanates or their equivalents include the trimethylolpropane trimer of TDI, and the like, isocyanurate trimers of TDI, HDI, IPDI, and the like, and biuret trimers of TDI, HDI, IPDI, and the like, as well as mixtures thereof. Examples of higher isocyanate functionalities include copolymers of TDI/HDI, and the like, and MDI oligomers, as well as mixtures thereof.

Suitable internal surfactants include both anionic and cationic internal surfactants. These include sulfonate diamines and diols, and dihydroxy carboxylic acids. In one embodiment, the internal surfactant is α,α-dimethylolpropionic acid (DMPA).

Any conventional urethane forming catalyst can be used in the prepolymer-forming reaction. Suitable urethane reaction catalyst, include, but are not limited to, dibutyl tindilaurate, bismuth tris-neodecanoate, cobalt benzoate, lithium acetate, stannous octoate, triethylamine, or the like.

The pigment dispersions of the present disclosure may be used in inkjet inks. The inkjet inks of the present embodiments can be prepared by diluting the pigment dispersion of the present embodiments with water or an aqueous solvent that contains water, and adding thereto other optional additives, e.g., humectant, plasticizer, contuctibity agents, defoamers, anti-oxidants, corrosion inhibitors, bactericides, pH control agents, if necessary.

The ink jet ink compositions may include a humectant. Examples of humectants include, but are not limited to, alcohols, for example, glycols such as 2,2′-thiodiethanol, glycerol, 1,3-propanediol, 1,5-pentanediol, polyethylene glycol, ethylene glycol, diethylene glycol, propylene glycol and tetraethylene glycol; pyrrolidones such as 2-pyrrolidone; N-methyl-2-pyrrolidone; N-methyl-2-oxazolidinone; and monoalcohols such as n-propanol and iso-propanol. The humectant may be present in an amount from about 2% to about 20%, or from about 4% to about 10% by weight of the ink composition.

The ink jet ink compositions may include a plasticizer. Examples of plasticizers include, but are not limited to, aliphatic polyols, phthalate esters (such as 1,6-hexane diol and dioctylphthalate), and other urethane compatible plasticizers.

The ink jet ink compositions may also include other components to impart characteristics desirable for ink jet printing applications. These optional components include conductivity agents, defoamers, anti-oxidants and corrosion inhibitors which improve ink manufacturing and printer performance; bacteriocides, which prevent bacterial attack that fouls ink manufacturing equipment and printers; and pH control agents, which insure that the components of the ink composition remain soluble throughout the operable range of water contents as well as throughout the period of storage and use.

The ink jet ink compositions of the present disclosure have a high degree of transparency and brightness. The inks of the present disclosure may have a surface tension in the range of about 20 dynes/cm to about 70 dynes/cm, or in the range 30 dynes/cm to about 50 dynes/cm; a viscosity in the range of about 1.0 to about 10.0, or about 1.0 to about 5.0 centipoise at room temperature.

The pigment dispersion particles remain stabilized or dispersed in a liquid carrying medium in the ink having a pH of from about 4 to about 10, from about 5 to about 9, or from about 6 to about 8.

### EXAMPLES

The following Examples further illustrate the present embodiments. All parts and percentages are by weight and all temperatures are degrees Celsius unless explicitly stated otherwise.

### Example 1

### Preparation of Neutralized Pre-Polymer

Pre-Dissolved DMPA/NMP Solution:

Into a 50 ml flask equipped with a Teflon coated stir magnetic was added 9.75 g of 2,2-bis(hydroxymethyl) propionic acid (DMPA, MW=134, available from Adrich Chemical of Milwaukee, Wis.) and 15.64 g of N-methylpyrrolidone (NMP). The mixture was heated at 70° C. with stifling until the DMPA was completely dissolved.

Pre-Polymer Formation:

Into a 1 L kettle equipped with a Trubore stirrer and Teflon stir paddle, temperature controller, 100 mL constant pressure addition funnel and N₂ inlet was charged 72.76 g pre-melted Terathane® 2000 (average Mn=2000 poly(tetrahydrofuran), available from Sigma-Aldrich). The kettle was secured in a bracket and the bottom ⅓ of the kettle was submerged in a 70° C. oil bath, and the contents were stirred for 15 minutes. The pre-dissolved DMPA/NMP solution was added to the kettle. After the contents were stirred for about 15 minutes, 42.4 g of isophorone diisocyanate (IPDI, MW=222, available from Huls America, Inc. of Piscataway, N.J.) was added to the kettle drop-wise through an addition funnel over about 30 minutes. A slight exotherm was observed. [Note: the charges of DMPA, terathane polyol (i.e., Terathane® 2000) and IPDI were charged so as to have a NCO/OH ratio of about 1.75 and a DMPA/Polyol ratio of about 2.0.] The reaction mixture was continued to be heated at 70° C. with stifling for about 3 hours and 45 minutes.

Neutralization:

The resulting mixture was added about 7.35 g of triethylamine (MW=101) with continuous stirring and heating at 70° C. After stirring and heating for about 15 minutes the neutralized pre-polymer was ready to be dispersion. The kettle containing the neutralized pre-polymer was transferred to the dispersing apparatus with the dispersion blade about 0.25 inch below the surface of the neutralized pre-polymer.

### Example 2

### Incorporation of Pigment in Polyurethane Dispersion

To the neutralized pre-polymer obtained from Example 1 was added 187 mL of chilled distilled water containing approximately 3.3% of solid pigment (Pro-Jet™ Cyan APD 1000, Pro-Jet™ Magenta APD 1000, Pro-Jet™ Black APD 1000, or Pro-Jet™ Yellow APD 1000 were used separately in each batch). The resulting mixture was dispersed at the highest speed (approximately 7,500 rpms) with an IKA® Crushing Disperser for about 15 seconds. A long wood tongue depressor was employed to scrape off the un-dispersed pre-polymer stucked on the wall of the kettle. The un-dispersed pre-polymer was placed onto the bottom of the blade of the IKA® Crushing Disperser and dispersed again for about 10 seconds at the highest rpm setting. An aqueous pigment dispersion of the neutralized propolymer was obtained.

### Example 3

### Chain Extension

To the aqueous pigment dispersion of the neutralized propolymer obtained in Example 2 was added dropwise an ethylene diamine solution (4.91 g ethylene diamine/10 g distilled water) over about 5 minutes. After stifling for about 1 hour, the resulting mixture was transferred to a 32 oz glass jar, capped and stored for at least 72 hours. At the end of the 72 hours, four pigment dispersions (i.e., Cyan-PUD, Magenta-PUD, Black-PUD, or Yellow-PUD) were obtained.

### Example 4

### Preparation of Aqueous Ink-Jet Inks

Into four separate 2-oz jars were each charged 10 g of a different pigment dispersions obtained from Example 3 and 2 g of 0.1M pH8 K₂HPO₄/KH₂PO₄ buffer and 8 g DI water. The contents were stirred for about 2 minutes.

The resulting inks were each loaded onto the corresponding empty ink cartridges (i.e., Cyan cartridge, Magenta cartridge, Black cartridge, and Yellow cartridge) for use in an ESPON WF-3540 printer, and prints were made of text and solid fill boxes with primary and secondary colors on Xerox 4200 paper as well as Xerox Digital Color Elite Gloss paper.

### Example 5

### Analysis and Measurements

Approximately 20 g of the each of the pigment dispersions (i.e., Cyan-PUD, Magenta-PUD, Black-PUD, or Yellow-PUD) obtained in Example 3 were separately poured into a 100 mm×10 cm petri dish top or bottom and allowed to dry/coalesce over a 48 hour period. The samples were pealed out of the Petri dish for future analysis.

A comparative experiment was conducted by adding and mixing a Pro-Jet Cyan pigment to a sample of a PUD containing no dyes or pigments. The resulting mixture was poured into a 100 mm×10 cm petri dish top or bottom and allowed to dry/coalesce over a 48 hour period. The sample was pealed out of the Petri dish and placed into a 100 mL jar containing water at about 70° C. The sample was allowed to cool to room temperature. After 24 hours, the sample was inspected and a cyan color in the water extract was observed. The same test was undertaken with the Cyan-PUD of this example and no color was visually observed in the water extract.

The average particle sizes of the commercial pigments and the pigment dispersions of Example 3 were measured by dynamic light scattering and the results were displaced in Table 1.

TABLE 1

| | Pigment Particle | PUD Particle |
|---|---|---|
| | Size (nm) | Size (nm) |
| Pro-Jet ™ Cyan | 132 | 117 |
| APD 1000 | | |
| Pro-Jet ™ Magenta | 128 | 107 |
| APD 1000 | | |
| Pro-Jet ™ Black | 123 | 128.6 |
| APD 1000 | | |
| Pro-Jet ™ Yellow | 153 | 148.9 |
| APD 1000 | | |

The viscosity (cps) and surface tension of the pigment dispersions at various concentrations obtained from Example 3 were measured and the data are shown in Table 2.

TABLE 2

| PUD/water ratio | | | |
|---|---|---|---|
| 100 | 75/25 | 50/50 | 25/75 |

CYAN-PUD

| | | | | |
|---|---|---|---|---|
| Viscosity at room temperature (cps) | 56.53 | 8.81 | 3.36 | 1.93 |
| Surface tension (dyn/cm) at room | 46.1 | | | |
| temperature | | | | |
| pH | 10.2 | | | |

MAGENTA-PUD

| | | | | |
|---|---|---|---|---|
| Viscosity at room temperature (cps) | 35.3 | 6.92 | 2.92 | 1.82 |
| Surface tension (dyn/cm) | 44.62 | | | |

BLACK-PUD

| | | | | |
|---|---|---|---|---|
| Viscosity at room temperature (cps) | 54.13 | 8.09 | 3.22 | 1.81 |
| Surface tension (dyn/cm) | 44.45 | | | |

YELLOW-PUD

| | | | | |
|---|---|---|---|---|
| Viscosity at room temperature (cps) | 61.56 | 8.76 | 3.31 | 1.80 |
| Surface tension (dyn/cm) | 45.77 | | | |

The resultant pigment dispersion and the ink jet inks including the pigment dispersion thereof both contain small particle size (i.e., pigment particle size, and ink particle size) and no settling.

1. A stable pigment dispersion comprising:
a polyurethane dispersion that is the reaction product of:
(a) a urethane prepolymer, the urethane prepolymer being a catalyzed reaction product of:
(i) a polyol;
(ii) a polyisocyanate; and
(iii) an internal surfactant;
(b) a neutralizing agent; and
(c) a chain extender; and
an aqueous pigment dispersion comprising a pigment that is not reactive towards the polyisocyanate;
wherein the stable pigment dispersion is obtained by a process comprising:
providing the urethane prepolymer;
reacting the urethane prepolymer with the neutralizing agent to form a neutralized prepolymer;
adding the aqueous pigment dispersion to the neutralized prepolymer to form an aqueous dispersion of the neutralized prepolymer; and
reacting the aqueous dispersion of the neutralized prepolymer with the chain extender thereby producing the stable pigment dispersion.

2. The pigment dispersion of claim 1 having an average dispersion particle size of from about 20 nm to about 900 nm.

3. The pigment dispersion of claim 1 having a viscosity of from about 2 to about 150 cps at room temperature.

4. The pigment dispersion of claim 1 having a surface tension of from about 15 to about 65 dyn at room temperature.

5. The pigment dispersion of claim 1, wherein the stoichiometric equivalent molar ratio of internal surfactant to polyol is from about 0.5 to about 2.0 and the stoichiometric equivalent molar ratio of NCO groups to total OH groups in the prepolymer is from about 1.2 to about 2.0.

6. The pigment dispersion of claim 1, wherein the pigment is present in the amount of from about 0.1 to about 30 percent by weight of the pigment dispersion.

7. The pigment dispersion of claim 1, wherein the pigment has an average pigment particle size of from about 20 nm to about 900 nm.

8. The pigment dispersion of claim 1, wherein the aqueous pigment dispersion comprises from about 1% to about 70% by weight of pigment based on the total weight of the aqueous pigment dispersion.

9. The pigment dispersion of claim 1, wherein the aqueous pigment dispersion is an oil-in-water dispersion

10. The pigment dispersion of claim 1, wherein the polyol is selected from the group consisting of polyether polyols, polyester polyols, polycarbonate polyols, silicone-based polyols and combinations thereof.

11. The pigment dispersion of claim 1, wherein the polyisocyanate is selected from the group consisting of aliphatic, cycloaliphatic, aromatic and heterocyclic polyisocyanates and combinations thereof.

12. The pigment dispersion of claim 1, wherein the internal surfactant is selected from the group consisting of anionic internal surfactants, cationic internal surfactants and combinations thereof.

13. The pigment dispersion of claim 1, wherein the neutralizing agent comprises trialkylamine.

14. The pigment dispersion of claim 1, wherein the chain extender is selected from the group consisting of diamines, triamines, diols, triols and combinations thereof.

15. (canceled)

16. The pigment dispersion of claim 1, wherein the aqueous pigment dispersion is an oil-in-water dispersion after the formation of the aqueous dispersion of the neutralized prepolymer.

17. A stable pigment dispersion comprising:
a polyurethane dispersion that is the reaction product of:
(a) a urethane prepolymer, the urethane prepolymer being a catalyzed reaction product of:
(i) a polyol;
(ii) a polyisocyanate; and
(iii) an internal surfactant;
wherein the stoichiometric equivalent molar ratio of internal surfactant to polyol is from about 0.5 to about 2.0 and the stoichiometric equivalent molar ratio of NCO groups to total OH groups in the prepolymer is from about 1.2 to about 2.0;
(b) a neutralizing agent; and
(c) a chain extender; and
an aqueous pigment dispersion comprising a pigment that is not reactive towards the polyisocyanate;
wherein the stable pigment dispersion is obtained by a process comprising:
providing the urethane prepolymer;
reacting the urethane prepolymer with the neutralizing agent to form a neutralized prepolymer;
adding the aqueous pigment dispersion to the neutralized prepolymer to form an aqueous dispersion of the neutralized prepolymer; and
reacting the aqueous dispersion of the neutralized prepolymer with the chain extender thereby producing the stable pigment dispersion;
further wherein the stable pigment dispersion has an average particle size of from about 20 nm to about 900 nm, a viscosity of from about 2 to about 150 cps at room temperature, and a surface tension of from about 15 to about 65 dyn at room temperature.

18. An ink jet ink composition comprising a stable pigment dispersion comprising:
a polyurethane dispersion that is the reaction product of:
(a) a urethane prepolymer, the urethane prepolymer being a catalyzed reaction product of:
(i) a polyol;
(ii) a polyisocyanate; and
(iii) an internal surfactant;
(b) a neutralizing agent; and
(c) a chain extender; and
a pigment dispersion comprising a pigment that is not reactive towards the polyurethance dispersion;
wherein the stable pigment dispersion is obtained by a process comprising:
providing the urethane prepolymer;
reacting the urethane prepolymer with the neutralizing agent to form a neutralized prepolymer;
adding the aqueous pigment dispersion to the neutralized prepolymer to form an aqueous dispersion of the neutralized prepolymer; and
reacting the aqueous dispersion of the neutralized prepolymer with the chain extender thereby producing the stable pigment dispersion.

19. The ink jet ink of claim 18, wherein the pigment dispersion has an average particle size of from about 20 nm to about 900 nm, a viscosity of from about 2 to about 150 cps at room temperature, and a surface tension of from about 15 to about 65 dyn at room temperature.

20. The ink jet ink of claim 18, wherein the ink has a surface tension of from about 20 dynes/cm to about 70 dynes/cm, a viscosity of from about 1.0 to about 10.0 centipoise at room temperature.
